(19) United States
(12) Patent Application Publication
(10) Pub. No.: US 2024/0046151 A1
(43) Pub. Date: Feb. 8, 2024

(54) METHOD AND ELECTRONIC DEVICE FOR AUTOMATED MACHINE LEARNING MODEL RETRAINING

(71) Applicant: SAMSUNG ELECTRONICS CO., LTD., SUWON-SI (KR)

(72) Inventors: Sukhdeep SINGH, Bangalore (IN); Vivek SAPRU, Bangalore (IN); Joseph THALIATH, Bangalore (IN); Ganesh Kumar THANGAVEL, Bangalore (IN); Ashish JAIN, Bangalore (IN); Seungil YOON, SUWON-SI (KR); Hoejoo LEE, Seoul (KR); Hunje YEON, Seoul (KR)

(21) Appl. No.: 18/305,712

(22) Filed: Apr. 24, 2023

Related U.S. Application Data
(63) Continuation of application No. PCT/KR2023/004503, filed on Apr. 4, 2023.

(30) Foreign Application Priority Data
Aug. 2, 2022 (IN) 202241044197

(51) Int. Cl. G06N 20/00

(52) U.S. Cl. CPC G06N 20/00

(57) ABSTRACT

A system and/or method for automated ML model retraining by an electronic device. The system and/or method may include one or more of: running a first ML model and a second ML model, predicting an accuracy degradation of the first ML model using the second ML model, determining whether the predicted accuracy degradation meets a pre-defined threshold, and/or retraining the first ML model when the predicted accuracy degradation meets the pre-defined threshold.

### CROSS-REFERENCE TO RELATED APPLICATIONS

This application is a continuation of International Application No. PCT/KR2023/004503, filed Apr. 4, 2023, designating the United States, in the Korean Intellectual Property Receiving Office, and claiming priority to IN Patent Application No. 202241044197, filed Aug. 2, 2022, in the Indian Patent Office, the disclosures of which are all hereby incorporated by reference herein in their entireties.

### BACKGROUND

### Technical Field

Various example embodiments relate to an electronic device, and/or to a method and electronic device for automated Machine Learning (ML) model retraining.

### Description of Related Art

Fifth Generation (5G) cellular network is a service-based architecture deployed for supporting 100s to 1000s of services. Management of the 5G cellular network and understanding patterns manually is very difficult task. Hence, operators incorporate Machine Learning (ML) based solutions which can understand and predict a problem in 5G cellular network in advance. Therefore, the operators can take decision to mitigate the problem in advance. There are millions of base stations and trillions of network devices are existing with their respective ML models in the 5G cellular network.

Network slicing is another important feature of the 5G cellular network to enable optimal use of network resources for multitude of services. Many solutions are currently existing for optimizing network slicing using the ML models. For most of these solutions to be effective training of the ML models is performed for each of the network slices. This involves collecting required amount of data for these slices for sufficient period of time before the ML models are trained and deployed. When the number of services and the network slices exponentially increase, there is a need to reduce ML resources by using existing already trained models. Since there will also be many new types of slices created, an amount of data available for training will be very limited.

The ML models may subject to performance degradation due to closed loop corrective/preventive actions taken for predicted problems overtime can change time series data and new unplanned events occur in the 5G cellular network may affect network Key Performance Indicators (KPIs). Also, new network service request having new and diverse service requirements may receive at the 5G cellular network that requires new network service/network slice deployment. Deployment of new network service/network slice for each new service request causes severe wastage of ML resources which can further lead to a non-optimized deployment in the 5G cellular network causes (QoS) degradation or Quality of Experience (QoE) degradation, not meeting a Service Level Agreement (SLA), high Operational Expenditure (OPEX) and leaving a subscriber from consuming the network services.

The above information is presented as background information only to assist with an understanding of the disclosure. No determination has been made, and no assertion is made, as to whether any of the above might be applicable as prior art with regard to the disclosure.

### SUMMARY

The performance degradation of the ML models can be prevented or reduced by ML model retraining by identifying the performance degradation on time. Also, ML model retraining is an expensive task as it requires specialized hardware like Graphics Processing Units (GPUs) or Tensor Processing Units (TPUs) and huge number of ML models expected to be deployed the process has to be automated. Service Providers need predictive and cheap means to retrain the ML models for making ML deployments for the 5G cellular network economically viable. Manual intelligent solutions are existing to identify the performance degradation of the ML models and rectify the performance degradation. However, the manual intelligent solutions dependents on human intervention that delay in handling the performance degradation of the ML models. Manually detecting the performance degradation of the ML models and manually mitigating the performance degradation may cause the QoS/QoE degradation of the services which is not beneficial for the operators. Thus, it is desired to provide automated prediction of the ML model performance degradation or possibility of data pattern changes to satisfy critical requirements of all service deployed in the 5G cellular networks.

Various example embodiments provide a method and/or an electronic device for automated ML model retraining. ML models require, or may be designed for, retraining due to performance degradation that occurs when accuracy of predictions of the ML models from new input values degrades compared to accuracy during a training period. An example proposed electronic device is predictive ML training resource management and optimizer that would reduce costs for ML model retraining.

Various example embodiments herein automatically deploy ML model retraining upon detecting the performance degradation of the ML model. The proposed method is for automating a process preventing or reducing performance degradation of the ML model which saves time. The proposed method solves a problem of increased Capital Expenditures (CAPEX) and OPEX due to intelligence, as operators can afford to have limited ML resources and servers, and cannot afford to waste the ML resources and servers in case of ML service degradation. The retraining enhances prediction accuracy of the ML model which in turn helps in optimizing network services.

Various example embodiments herein intelligently and/or automatically identify a suitable trained ML super model to be used for predictions for a newly created network slices for which only minimum amount data is available.

Accordingly, Various example embodiments herein provide a method for automated ML model retraining by an electronic device. The method may include running, by the electronic device, a first ML model and a second ML model. The method may include predicting, by the electronic device, an accuracy degradation of the first ML model using the second ML model. The method may include determining, by the electronic device, whether the predicted accuracy degradation meets a pre-defined threshold. The method may include retraining, by the electronic device, the first ML model when the predicted accuracy degradation meets the pre-defined threshold.

In an example embodiment, where the accuracy degradation is due to unplanned events occurring in the first ML model.

In an example embodiment, where predicting, by the electronic device, the accuracy degradation of the first ML model using the second ML model, may include receiving, by the electronic device, data of accuracy of the first ML model comprising at least one of a model type, parameters and hyper parameters, network nodes, cell models, slice/cell configuration information, existing models that can be used for transfer learning, model training time, model prediction accuracies, resources used for model training, extraction times, time window of data extraction, data generation patterns, model accuracy data, and execution time for each training pipeline; storing, by the electronic device, the data of accuracy of the first ML model to a retraining datastore; and predicting, by the electronic device, the accuracy degradation of the first ML model by analyzing the data of accuracy of the first ML model with the second ML model.

In an example embodiment, where retraining, by the electronic device, the first ML model may include estimating, by the electronic device, an expected time for completion of the model retraining and data extraction based on data of accuracy stored in a retraining datastore; extracting, by the electronic device, the data of accuracy of the first ML model from the retraining datastore; predicting, by the electronic device, incoming requests of the first ML model; estimating, by the electronic device, the resources and resource constraints; creating, by the electronic device, a plan for retraining the first ML model based on the predicted incoming requests, the expected time for completion of the retraining, the estimated resources, and the resource constraints; and scaling, by the electronic device, up/down and in/out ML the resources based on the created plan; and triggering, by the electronic device, retraining of the first ML model based on the created plan.

In another example embodiment, where retraining, by the electronic device, the first ML model may include receiving, by the electronic device, a request to configure a ML service with a new network slice; determining, by the electronic device, a network slice with the first ML model similar to the new network slice and capable for transfer learning; predicting, by the electronic device, super models of the first ML model used for transfer learning, and remaining layers of the first ML model to be retrained based on inputs from a model registry; and triggering, by the electronic device, retraining of the remaining layers of the first ML model.

Various example embodiments provide an electronic device for automated ML model retraining. The electronic device may include a proactive retraining engine comprising circuitry, a memory, a processor, where the proactive retraining engine is coupled, directly or indirectly, to the memory and the processor. The proactive retraining engine may be configured for running the first ML model and the second ML model. The proactive retraining engine may be configured for predicting the accuracy degradation of the first ML model using the second ML model. The proactive retraining engine may be configured for determining whether the predicted accuracy degradation meets the pre-defined threshold. The proactive retraining engine may be configured for retraining the first ML model when the predicted accuracy degradation meets the pre-defined threshold.

These and other aspects of example embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments, and example embodiments herein include all such modifications.

### BRIEF DESCRIPTION OF THE DRAWINGS

The above and other aspects, features, and advantages of certain embodiments will be more apparent from the following detailed description, taken in conjunction with the accompanying drawings, in which:

FIG. 1 is a block diagram of an electronic device for automated ML model retraining, according to an example embodiment;

FIG. 2 is a block diagram of a system includes a proactive retraining engine for retraining a first ML model with accuracy degradation, according to an example embodiment;

FIG. 3 is a flow diagram illustrating a method for automated ML model retraining, according to an example embodiment;

FIG. 4 is a flow diagram illustrating an internal working of an intelligent resource optimization scheduling engine for automated accuracy degrade prediction of the first ML model in telecom domain, according to an example embodiment;

FIG. 5 is a flow diagram illustrating an internal working of a transfer learning manager for intelligent automated transfer of learning for network slices, according to an example embodiment;

FIGS. 6A to 6C illustrate a comparison an existing method of ML model retraining with the proposed method of automated ML model retraining, according to an example embodiment;

FIG. 7 illustrates different network architecture implementations with the proactive retraining engine, according to an example embodiment;

FIG. 8 illustrates an example scenario of automated ML model retraining in response to accuracy degradation of the first ML model, according to an example embodiment;

FIG. 9 illustrates an example scenario of automated ML model retraining due in response to receiving a new service request, according to an example embodiment; and

FIG. 10 illustrates a wireless communication system, according to according to an example embodiment.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various examples of the disclosure described below, a hardware approach will be described as an example. However, since various embodiments of the disclosure may include a technology that utilizes both the hardware-based and the software-based approaches, they are not intended to exclude the software-based approach.

As used herein, the terms referring to merging (e.g., merging, grouping, combination, aggregation, joint, integration, unifying), the terms referring to signals (e.g., packet, message, signal, information, signaling), the terms referring to resources (e.g. section, symbol, slot, subframe, radio frame, subcarrier, resource element (RE), resource block (RB), bandwidth part (BWP), opportunity), the terms used to refer to any operation state (e.g., step, operation, procedure), the terms referring to data (e.g. packet, message, user stream, information, bit, symbol, codeword), the terms referring to a channel, the terms referring to a network entity (e.g., distributed unit (DU), radio unit (RU), central unit (CU), control plane (CU-CP), user plane (CU-UP), O-DU-open radio access network (O-RAN) DU), O-RU (O-RAN RU), O-CU (O-RAN CU), O-CU-UP (O-RAN CU-CP), O-CU-CP (O-RAN CU-CP)), the terms referring to the components of an apparatus or device, or the like are only illustrated for convenience of description in the disclosure. Therefore, the disclosure is not limited to those terms described below, and other terms having the same or equivalent technical meaning may be used therefor. Further, as used herein, the terms, such as ‘˜module’, ‘˜unit’, ‘˜part’, ‘˜body’, or the like may refer to at least one shape of structure or a unit for processing a certain function.

Further, throughout the disclosure, an expression, such as e.g., ‘above’ or ‘below’ may be used to determine whether a specific condition is satisfied or fulfilled, but it is merely of a description for expressing an example and is not intended to exclude the meaning of ‘more than or equal to’ or ‘less than or equal to’. A condition described as ‘more than or equal to’ may be replaced with an expression, such as ‘above’, a condition described as ‘less than or equal to’ may be replaced with an expression, such as ‘below’, and a condition described as ‘more than or equal to and below’ may be replaced with ‘above and less than or equal to’, respectively. Furthermore, hereinafter, ‘A’ to ‘B’ means at least one of the elements from A (including A) to B (including B). Hereinafter, ‘C’ and/or ‘D’ means including at least one of ‘C’ or ‘D’, that is, {′C′, ‘D’, or ‘C’ and ‘D’}.

The disclosure describes various embodiments using terms used in some communication standards (e.g., 3rd Generation Partnership Project (3GPP), extensible radio access network (xRAN), open-radio access network (O-RAN) or the like), but it is only of an example for explanation, and the various embodiments of the disclosure may be easily modified even in other communication systems and applied thereto.

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure example embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which example embodiments herein can be practiced and to further enable those skilled in the art to practice example embodiments herein. Accordingly, the examples should not be construed as limiting the scope of example embodiments herein.

Embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope. Likewise, the blocks of the embodiments may be physically combined into more complex blocks without departing from the scope.

The accompanying drawings are used to help easily understand various technical features and it should be understood that the example embodiments are not limited by the accompanying drawings. As such, various embodiments should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Throughout this disclosure, the terms “accuracy degradation” and “performance degradation” are used interchangeably and mean the same.

Accordingly, example embodiments herein provide a method for automated ML model retraining by an electronic device. The method includes running, by the electronic device, a first ML model and a second ML model. The method includes predicting, by the electronic device, an accuracy degradation of the first ML model using the second ML model. The method includes determining, by the electronic device, whether the predicted accuracy degradation meets a pre-defined threshold. The method includes retraining, by the electronic device, the first ML model when the predicted accuracy degradation meets the pre-defined threshold.

Accordingly, example embodiments herein provide the electronic device for automated ML model retraining. The electronic device includes a proactive retraining engine comprising circuitry, a memory, a processor, where the proactive retraining engine is coupled, directly or indirectly, to the memory and the processor. The proactive retraining engine is configured for running the first ML model and the second ML model. The proactive retraining engine is configured for predicting the accuracy degradation of the first ML model using the second ML model. The proactive retraining engine is configured for determining whether the predicted accuracy degradation meets the pre-defined threshold. The proactive retraining engine is configured for retraining the first ML model when the predicted accuracy degradation meets the pre-defined threshold.

The proactive retraining engine may automatically predict when the first ML model would require retraining. The proactive retraining engine may automatically predict the resource requirements for training the first ML model training. The proactive retraining engine may provide a platform that optimizes and reduces training/retraining resources. The proactive retraining engine may automate use of the transfer learning from a previous ML model to reduce time and cost of new ML models for network rollout (i.e. use of super models).

The proactive retraining engine may include a data store to keep historical information about previous training/retraining, a set of 3 neural networks for: predicting when the ML model accuracy goes below the pre-defined threshold, predicting a time required for data extraction and transformation for retraining a specific ML model, and predicting a time and resources over time required for retraining of the ML model.

The automated method of predicting the accuracy degradation of the first ML model by resource management and optimization may reduce costs for ML model retraining. Further, the electronic device may periodically predict the accuracy degradation of the first ML model and notifies for changes to top N important cell and slice parameters. Further, the electronic device may predict when the accuracy degradation of the first ML model goes below the pre-defined threshold, which further cause to trigger for retraining of the first ML model. Further, the electronic device may predict the time required for data extraction and transformation for training a specific ML model retraining. Further, the electronic device may predict the time and the resources over time required for retraining of the first ML model. A retraining datastore of the electronic device may keep historical information about previous training/retraining of the first ML model. Also, the proposed method for an example embodiment may allow the electronic device for intelligent automated transfer learning for network slices by detecting slice similarity and detecting a best ML model to be used for the transfer learning.

Unlike certain existing methods and systems, for already trained ML models running in a system, the proactive retraining engine may for example pro-actively predict when the trained ML models will degrade and cross the pre-defined threshold using an artificial intelligence-based method, and accordingly triggers the retraining of the trained ML models before the degradation crosses the pre-defined threshold. Thus, the proactive retraining engine may take at least one step ahead and predict when to retrain the trained ML models, and may retrain before the ML model degradation cross the limit. Thus, the automation to prevent or reduce ML service degradation can save time.

Unlike certain existing methods and systems, upon receiving a new service request, the proactive retraining engine may find out a supermodel for the new service request and may determine the layers of the ML model that can be re-used and the layers require retraining for providing the service. Also, the proactive retraining engine may pro-actively identify a best suitable training model for the retraining. Thus, prediction accuracies can be further enhanced which can in turn help in optimizing the network services.

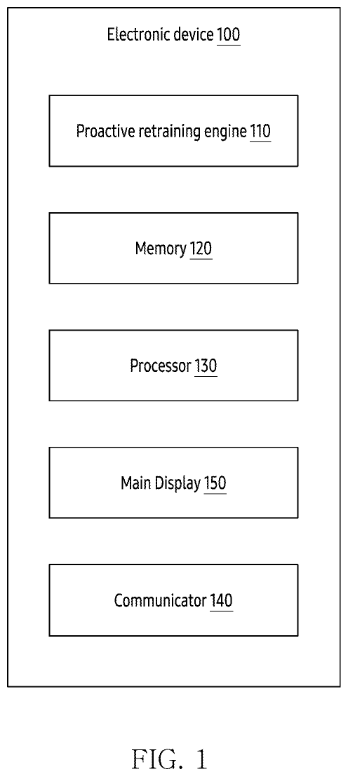

Referring now to the drawings, and more particularly to FIGS. 1 through 9, there are shown various example embodiments. Each embodiment herein may be used in combination with any other embodiment described herein.

FIG. 1 is a block diagram of an electronic device (100) for automated ML model retraining, according to an example embodiment. Examples of the electronic device (100) include, but are not limited to a smartphone, a tablet computer, a Personal Digital Assistance (PDA), a desktop computer, an Internet of Things (IoT), a wearable device, etc. In an embodiment, the electronic device (100) includes a proactive retraining engine (110) comprising circuitry, a memory (120), at least one processor (130) comprising processing circuitry, a communicator (140) comprising communication circuitry, and a main display (150), where the main display is a physical hardware component that can be used to display to a user. Examples of the main display include, but are not limited to a light emitting diode display, a liquid crystal display, a projector, etc. The proactive retraining engine (110) may be implemented by processing circuitry such as one or more of: logic gates, integrated circuits, microprocessors, microcontrollers, memory circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like.

A first ML model and a second ML model run in the electronic device (100). The proactive retraining engine (110) predicts an accuracy degradation of the first ML model using the second ML model. The accuracy degradation is due to unplanned events occurring in the first ML model. Further, the proactive retraining engine (110) determines whether the predicted accuracy degradation meets a pre-defined threshold. Further, the proactive retraining engine (110) retrains the first ML model when the predicted accuracy degradation meets the pre-defined threshold.

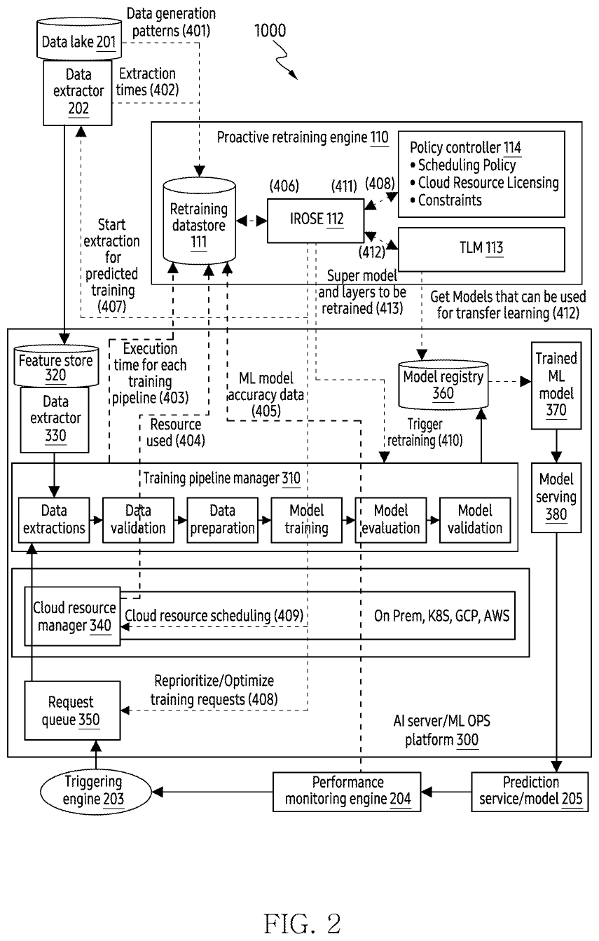

In an embodiment, the proactive retraining engine (110) receives data of accuracy of the first ML model including a model type, parameters and hyper parameters, network nodes, cell models, slice/cell configuration information, existing models that can be used for transfer learning, model training time, model prediction accuracies, resources used for model training, extraction times, time window of data extraction, data generation patterns, model accuracy data, and execution time for each training pipeline. Further, the proactive retraining engine (110) stores the data of accuracy of the first ML model to a retraining datastore (111) (refer FIG. 2). Further, the proactive retraining engine (110) predicts the accuracy degradation of the first ML model by analyzing the data of accuracy of the first ML model with the second ML model.

In an embodiment, the proactive retraining engine (110) estimates an expected time for completion of the model retraining and data extraction based on data of accuracy stored in a retraining datastore (111). Further, the proactive retraining engine (110) extracts the data of accuracy of the first ML model from the retraining datastore (111). Further, the proactive retraining engine (110) predicts incoming requests of the first ML model. Further, the proactive retraining engine (110) estimating the resources and resource constraints. Further, the proactive retraining engine (110) creates a plan for retraining the first ML model based on the predicted incoming requests, the expected time for completion of the retraining, the estimated resources, and the resource constraints. Further, the proactive retraining engine (110) scales up/down and in/out the resources based on the created plan. Further, the proactive retraining engine (110) triggers retraining of the first ML model based on the created plan.

In another embodiment, the proactive retraining engine (110) receives a request to configure a ML service with a new network slice. Further, the proactive retraining engine (110) determines a network slice with the first ML model similar to the new network slice and capable for transfer learning. Further, the proactive retraining engine (110) predicts super models of the first ML model used for transfer learning, and remaining layers of the first ML model to be retrained based on inputs from a model registry. Further, the proactive retraining engine (110) triggers retraining of the remaining layers of the first ML model.

The memory (120) stores the first ML model and the second ML model. The memory (120) stores instructions to be executed by the processor (130). The memory (120) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (120) may, in some examples, be considered a non-transitory storage medium. The term “non-transitory” may indicate that the storage medium is not embodied in a carrier wave or a propagated signal. However, the term “non-transitory” should not be interpreted that the memory (120) is non-movable. In some examples, the memory (120) can be configured to store larger amounts of information than its storage space. In certain examples, a non-transitory storage medium may store data that can, over time, change (e.g., in Random Access Memory (RAM) or cache). The memory (120) can be an internal storage unit or it can be an external storage unit of the electronic device (100), a cloud storage, or any other type of external storage.

The processor (130) is configured to execute instructions stored in the memory (120). The processor (130) may be a general-purpose processor, such as a Central Processing Unit (CPU), an Application Processor (AP), or the like, a graphics-only processing unit such as a Graphics Processing Unit (GPU), a Visual Processing Unit (VPU) and the like. The processor (130) may include multiple cores to execute the instructions. The communicator (140) is configured for communicating internally between hardware components in the electronic device (100). Further, the communicator (140) is configured to facilitate the communication between the electronic device (100) and other devices via one or more networks (e.g. Radio technology). The communicator (140) includes an electronic circuit specific to a standard that enables wired or wireless communication.

A function associated with the ML models may be performed through the non-volatile/volatile memory (120), and the processor (130). The one or a plurality of processors (130) control the processing of the input data in accordance with a predefined operating rule or the ML models stored in the non-volatile/volatile memory (120). The predefined operating rule or the ML models are provided through training or learning. Here, being provided through learning indicates that, by applying a learning method to a plurality of learning data, the predefined operating rule or the ML models of a desired characteristic is made. The learning may be performed in the electronic device (100) itself in which the ML models according to an embodiment is performed, and/or may be implemented through a separate server/system. The ML models may be of or include a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks. The learning method is a method for training a predetermined target device (for example, a robot) using a plurality of learning data to cause, allow, or control the target device to make a determination or prediction. Examples of the learning method include, but are not limited to, supervised learning, unsupervised learning, semi-supervised learning, or reinforcement learning.

Although the FIG. 1 shows the hardware components of the electronic device (100) but it is to be understood that other embodiments are not limited thereon. In other embodiments, the electronic device (100) may include less or a greater number of components. Further, the labels or names of the components are used only for illustrative purpose and does not limit the scope. One or more components can be combined together to perform same or substantially similar function for automated ML model retraining.

FIG. 2 is a block diagram of a system (1000) includes the proactive retraining engine (110) for retraining the first ML model with the accuracy degradation, according to an example embodiment. In an embodiment, the system (1000) can be the electronic device (100). The system (1000) includes the proactive retraining engine (110), a data lake (201), a data extractor (202), an Artificial Intelligence (AI) server or a Machine Learning Model Operations (ML OPS) platform (300), a performance monitoring engine (204), a triggering engine (203) and a prediction service/model (205).

In an embodiment, the proactive retraining engine (110) includes the retraining datastore (111), an Intelligent Resource Optimization Scheduling Engine (IROSE) (112), a Transfer Learning Manager (TLM) (113), and a policy controller (114). The retraining datastore (111), the IROSE (112), the TLM (113), and the policy controller (114) are implemented by processing circuitry such as logic gates, integrated circuits, microprocessors, microcontrollers, memory circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like. Each processor herein comprises processing circuitry.

The proactive retraining engine (110) is connected, directly or indirectly, to the data lake/storage/memory (201), the data extractor (202), the AI/ML OPS platform (300), and the performance monitoring engine (204), where the AI server and/or the ML OPS platform (300) is connected, directly or indirectly, to the triggering engine (203) and the prediction service/model (205). The AI server and/or the ML OPS platform (300) includes a training pipeline manager (310), a feature store (320), a data extractor (330), a cloud resource manager (340), a request queue (350), a model registry (360), a trained ML model (370), and a model server (380). The training pipeline manager (310) sequentially performs data extractions, data validation, data preparation, model training, model evaluation, and model validation. On Prem, KBS, GCP, AWS are examples for the cloud resource manager (340).

At 401-405, the retraining datastore (111) collects information of current ML model accuracy from different platforms includes the data lake (201), the data extractor (202), the training pipeline manager (310), the cloud resource manager (340), and a performance monitoring engine (204). The retraining datastore (111) have adapters to collect information of the first ML model performance for monitoring. The retraining datastore (111) collects the real data and predicted information, and provides feedback based on the prediction accuracy. The retraining datastore (111) stores the collected data which is a continuous ongoing process. The retraining datastore (111) passes on this data to the IROSE (112), where the IROSE (112) further predict the need for retraining or transfer learning of the first ML model.

The IROSE (112) predicts ML model retraining for already running ML services or new network service request. At 406, the IROSE (112) predicts the data extraction time for each ML model based on the data in the retraining datastore (111). The IROSE (112) predicts the training time for each request and each resource for each request using reinforcement learning based on the data in the retraining datastore (111). The IROSE (112) triggers the created plan as actions. After deploying the updated ML model, the IROSE (112) decides whether to keep the new ML model in the electronic device (100) or rollback to previous ML model according to the performance monitoring result after having feedback of the newly deployed model. At 407, the IROSE (112) triggers data extraction for a particular use case for which retraining is expected. At 408, the IROSE (112) creates the execution plan (i.e. request to train serially and/or parallel) based on the predicted incoming requests, the predicted time for completion of training, the estimated resources and the resource constraints so as to reduce the overall training time. At 409, the IROSE (112) scales up/down or in/out the resources based on the predicted training plan. At 410, the IROSE (112) triggers the retraining in the training pipeline manager (310) based on the actions performed in steps 407-409 to create the trained ML model (370).

At 411, a new network slice is to be deployed in the network, i.e. the ML service needs to be configured in new slice. The IROSE (112) compares and finds the nearest slice with the same ML service. At 412, the IROSE (112) contacts the TLM (113), where the TLM (113) predicts the super models used for the transfer learning and finds the number of remaining layers to be retrained based on inputs from the model registry (360). At 413, the IROSE (112) then triggers the TLM (113) with the super model and layers to be retrained as input to create the trained ML model (370).

The TLM (113) predicts the ML models those are best suited to be used for the transfer learning to the newly trained ML model, which can also be a parameter in the training request. The TLM (113) uses deep dynamic learning to identify the number of layers of the first ML model are to be retrained.

The policy controller (114) may include a YAML file that can be used to define scheduling parameters, policies, and/or maximum possible scalable load.

Although the FIG. 2 shows the hardware components of the proactive retraining engine (110), but it is to be understood that other embodiments are not limited thereon. In other embodiments, the proactive retraining engine (110) may include less or a greater number of components. Further, the labels or names of the components are used only for illustrative purpose and does not limit the scope. One or more components can be combined together to perform same or substantially similar function for retraining the first ML model with the accuracy degradation.

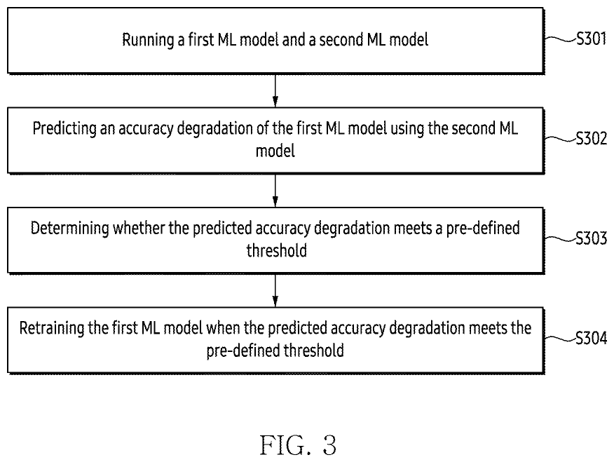

FIG. 3 is a flow diagram (S300) illustrating a method for automated ML model retraining, according to an example embodiment. In an embodiment, the method allows the proactive retraining engine (110) to perform steps S301-S304 of the flow diagram (S300). At step S301, the method includes running the first ML model and the second ML model. At step S302, the method includes predicting the accuracy degradation of the first ML model using the second ML model. At step S303, the method includes determining whether the predicted accuracy degradation meets the pre-defined threshold. At step S304, the method includes retraining the first ML model when the predicted accuracy degradation meets the pre-defined threshold.

The proposed method considers different wide range of scenarios that can cause the ML model performance degradation. Also, a detailed architecture is proposed in this disclosure to detect the ML model performance degradation and explains how it will co-exist and co-work with an AI server.

The various actions, acts, blocks, steps, or the like in the flow diagram (S300) may be performed in the order presented, in a different order, or simultaneously. Further, in some embodiments, some of the actions, acts, blocks, steps, or the like may be omitted, added, modified, skipped, or the like without departing from the scope.

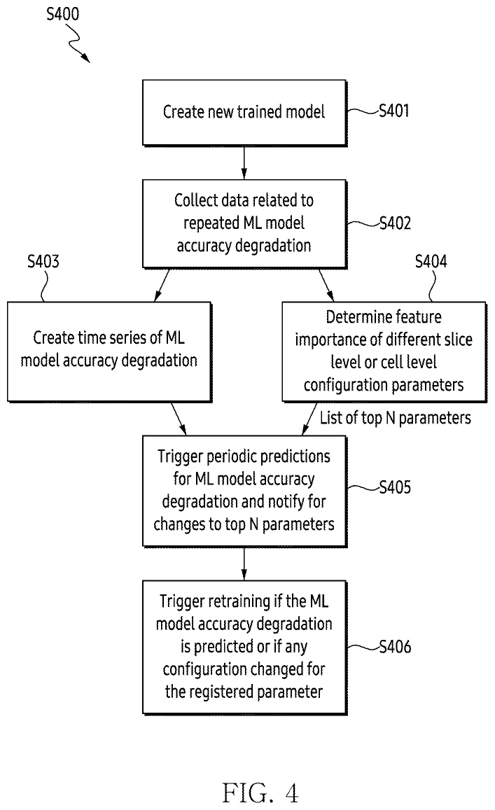

FIG. 4 is a flow diagram (S400) illustrating an internal working of the IROSE (112) for automated accuracy degrade prediction of the first ML model in telecom domain, according to an example embodiment. A closed loop corrective/preventive actions taken for predicted problems overtime can change time series data. At S401, a new trained model (e.g. first ML model) is created at the electronic device (100), where no data is available for model degradation at this stage. At S402, the IROSE (112) collects the data related to repeated ML model accuracy degradation includes detection of data pattern change or model prediction error, and slice level or cell level configuration snapshot. At S403, the IROSE (112) creates time series of the ML model accuracy degradation upon detecting ML model accuracy degradation. Alternatively, at S404, the IROSE (112) determines feature importance of different slice level or cell level configuration parameters and a list of top N parameters upon receiving the service request. At S405, the IROSE (112) triggers the periodic predictions for the ML model accuracy degradation and notifies for changes to the top N parameters. At S406, the IROSE (112) triggers retraining if the ML model accuracy degradation is predicted or if any configuration changed for the registered parameter. Thus, the IROSE (112) predicts the ML model accuracy degradation in advance and triggers the retraining of the ML model early so that the ML model is updated in shorter time.

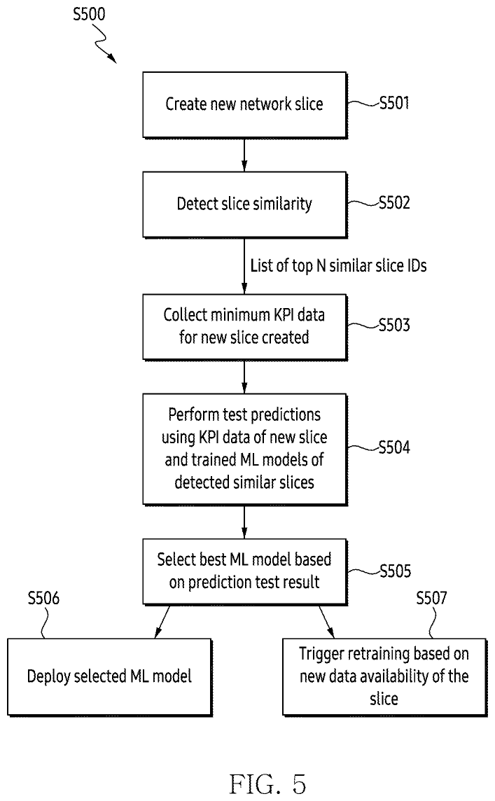

FIG. 5 is a flow diagram (S500) illustrating an internal working of the TLM (113) for the intelligent automated transfer of learning for the network slices, according to an example embodiment. At S501, a new network slice (e.g. first ML model) is created at the electronic device (100), where no KPI data available for the newly created network slice. Hence, the ML model cannot be trained and deployed. At S502, the TLM (113) detects slice similarity by comparing slice configuration parameters based on threshold configurations and provides a list of top N similar slice IDs. At S503, the TLM (113) may for example collect minimum KPI data (e.g. 7 days of KPI data) for new slice created. At S504, the TLM (113) may perform test predictions using the KPI data of the new slice and the trained ML models of detected similar slices. At S505, the TLM (113) may select best ML model based on prediction of test result. At S506, the TLM (113) may deploy the selected ML model. At S507, the TLM (113) triggers retraining based on new data availability of the slice.

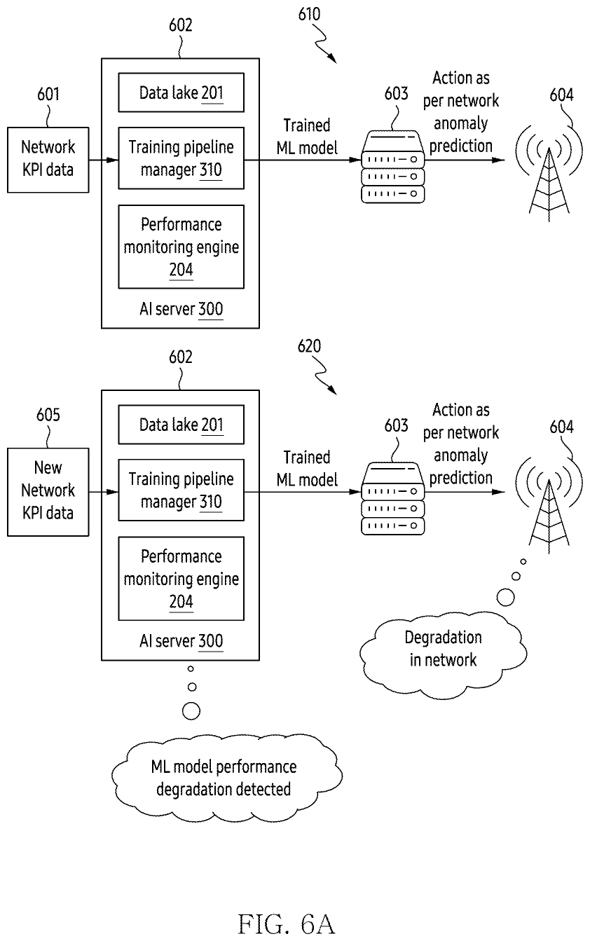

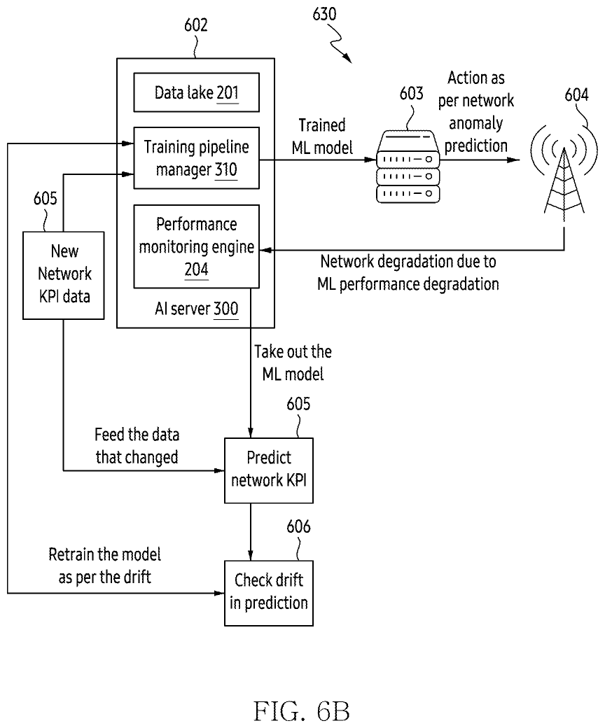

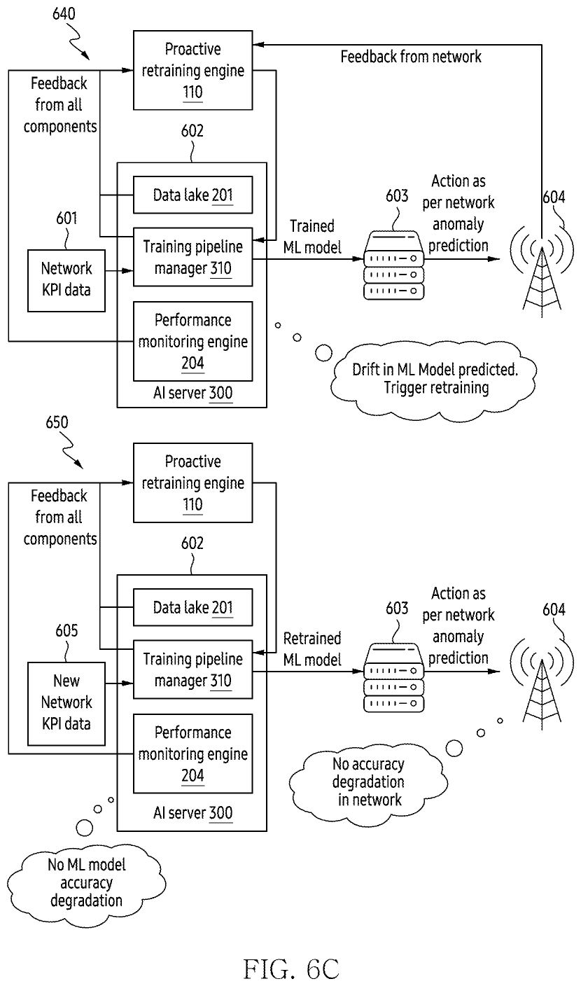

FIGS. 6A to 6C illustrate a comparison an existing method of ML model retraining with the proposed method of automated ML model retraining, according to an example embodiment. The FIGS. 6A and 6B show three phases of the existing method of ML model retraining. In first phase of the existing method as shown in 610, at 602 the training pipeline manager (310) of the AI server (300) analyses the network KPI data (601) and trains the ML model (603) and predicts anomaly at the network (604) and takes preventive or reducing measures.

In second phase of the existing method as shown in 620, new network KPI data (605) is generated after the preventive/reducing measures. Further, the AI server (300) detects ML model performance degradation, and the ML model performance degradation further causes degradation in the network (604).

In third phase of the existing method as shown in 630, upon detecting the degradation in the network (604), the performance monitoring engine (204) of the AI server (300) takes out the ML model and predicts network KPI based on the change in the network KPI data. Further, the performance monitoring engine (204) checks for drift in the prediction with respect to previous predictions and retrains the ML model as per the drift (e.g., see 606 in FIGS. 6A and 6B).

The FIG. 6C shows two phases of the proposed method of automated ML model retraining. In first phase of the proposed method as shown in 640, the training pipeline manager (310) of the AI server (300) analyses the network KPI data (601) and trains the ML model (603), predicts anomaly at the network (604) and takes preventive/reducing actions as per the anomaly. In parallel, the proactive retraining engine (110) receives the accuracy data from all components (201, 310, 204) of the AI server (300), and feedback from the network (604) and detects checks for the change in the KPI data due to changes in network updates, configuration or traffic patterns and predict drift in the ML Model. The proactive retraining engine (110) proactively detects and triggers the AI server (300) to retrain the ML model so, that when the new KPI data is available then no ML model degradation occurs.

In second phase of the proposed method as shown in 650, the new network KPI data (605) is generated after the preventive/reducing actions and training has done as per the retrained model proactively. So, no ML model accuracy degradation occurs at the AI server (300) and no accuracy degradation occurs in the network (604).

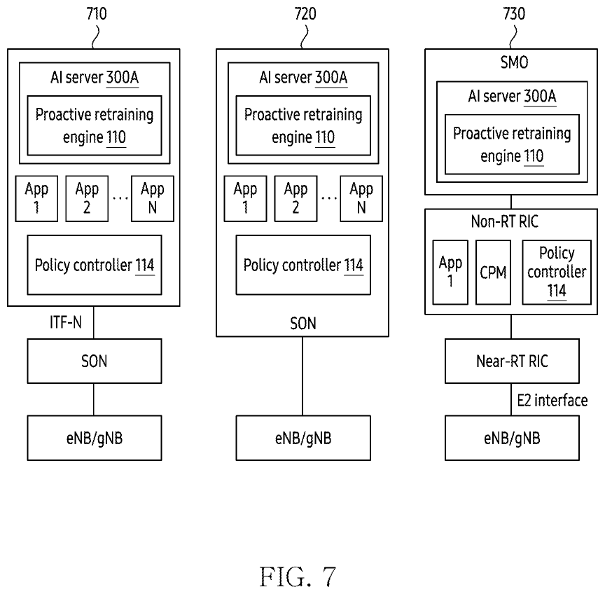

FIG. 7 illustrates different network architecture implementations with the proactive retraining engine (110), according to an example embodiment. A network architecture implementation shown in (710) includes an independent server, a Self-Organizing Network (SON) server, and an eNodeB/gNnodeB (eNB/gNB). The independent server is connected, directly or indirectly, to the SON through an Interface N (ITF-N). The SON is connected, directly or indirectly, to the eNB/gNB. The independent server includes an AI server (300A) with the proactive retraining engine (110), a plurality of applications (App1-AppN), and the policy controller (114).

Another network architecture implementation shown in (720) includes the SON/SON server connected to the eNB/gNB. The SON server includes the AI server (300A) with the proactive retraining engine (110), the plurality of applications (App1-AppN), and the policy controller (114).

Another network architecture implementation shown in (730) is an Open Radio Access Network (O-RAN) compliant architecture includes a Service Management and Orchestration (SMO), a Non-Real Time Radio Intelligent Controller (non-RT RIC), a Near Real Time Radio Intelligent Controller (near-RT RIC), and the eNB/gNB. The SMO is connected, directly or indirectly, to the non-RT RIC. The non-RT RIC is connected, directly or indirectly, to the near-RT RIC. The near-RT RIC is connected, directly or indirectly, to the eNB/gNB through at least a E2 interface. The SMO includes the AI server (300A) with the proactive retraining engine (110). The non-RT RIC includes the application (App 1), a Congestion Prediction and Mitigation (CPM), and the policy controller (114).

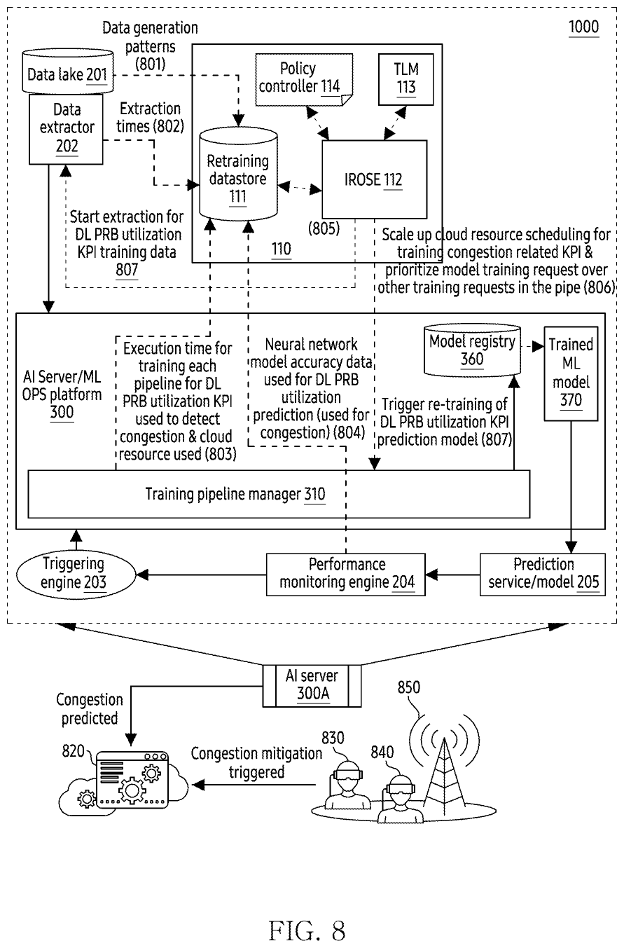

FIG. 8 illustrates an example scenario of automated ML model retraining in response to the accuracy degradation of the first ML model, according to an example embodiment. The AI server (300A) is an example for the system (1000). Consider, the AI server (300A) is providing a Virtual Reality (VR) service to at least a VR device (840) through a cellular network (850). Later, another VR device (830) started accessing the VR service via the cellular network (850), which creates a congestion in the cellular network for providing the VR service to multiple VR devices (830, 840). A main reason for the congestion is due to performance degradation of the ML model of the AI server (300A) in providing the VR service to multiple VR devices (830, 840). Upon predicting the congestion in the cellular network, the AI server (300A) triggers retraining of the ML model to handle the network resources for providing the VR service to the multiple VR devices (830, 840) without creating congestion (e.g., see 820).

For triggering retraining of the ML model, the retraining datastore (111) collects and stores the data of accuracy includes the data generation patterns (801) from the data lake (201), the extraction times (802) from the data extractor (202), a execution time for training each pipeline for DL PRB utilization KPI used to detect congestion & cloud resource used (803) from the training pipeline manager (310), and a neural network model accuracy data used for DL PRB utilization prediction used for congestion (804) from the performance monitoring engine (204). At 805, the IROSE (112) predicts DL PRB utilization KPI prediction model degradation due to change in KPI data pattern in a field based on the data of accuracy. Further, at 806 the IROSE (112) scales up cloud resource scheduling for training congestion related KPI & prioritizes model training request over other training requests in the training pipeline manager (310). Further, at 807 the IROSE (112) starts retraining of DL PRB utilization KPI prediction model.

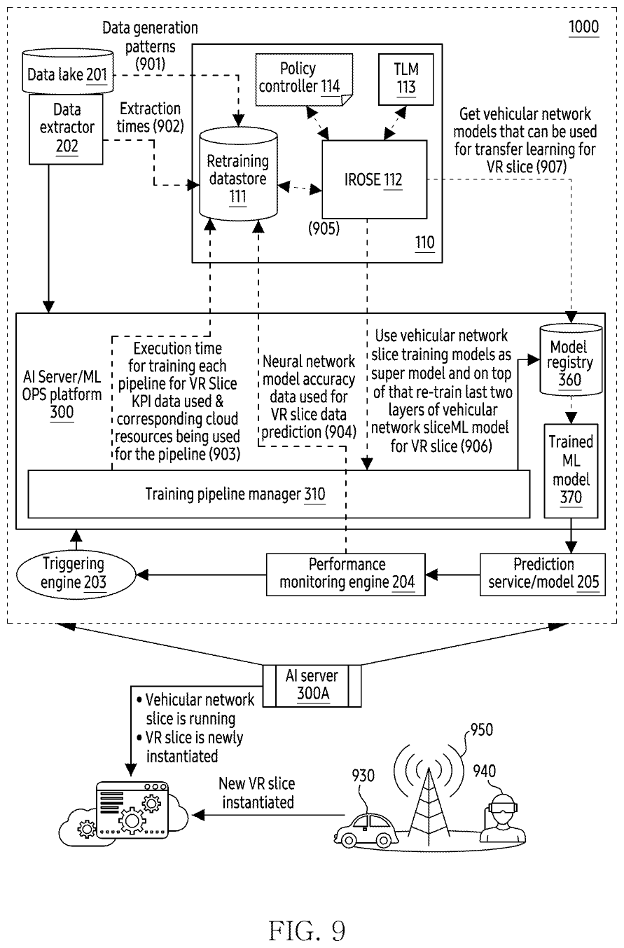

FIG. 9 illustrates an example scenario of automated ML model retraining due in response to receiving the new service request, according to an example embodiment. The AI server (300A) is an example for the system (1000). Consider, the AI server (300A) is running a vehicular network slice for a car (930) through a cellular network (950). Later, a VR device (940) joined the cellular network (950) and requested for accessing the VR service via the cellular network (950). Based on the request, the AI server (300A) creates a VR slice with a new ML model for providing VR service to the VR device (940). The new ML model is created using the proposed method.

Initially, the retraining datastore (111) collects and stores the data of accuracy includes the data generation patterns (901) from the data lake (201), the extraction times (902) from the data extractor (202), an execution time for training each pipeline for VR slice KPI data used & corresponding cloud resources being used for the pipeline (903) from the training pipeline manager (310), and a neural network model accuracy data used for VR slide data prediction (904) from the performance monitoring engine (204). At 905, the IROSE (112) detects the new service request for VR slice in the network field which is similar to vehicular network slice in the cellular network (950) based on the data of accuracy. Further at 906, the IROSE (112) uses the vehicular network slice training models as the super model and on top of that retrains last two layers of the vehicular network slice ML model for the VR slice. Further at 907, the IROSE (112) gets the vehicular network models that can be used for transfer learning for VR slice.

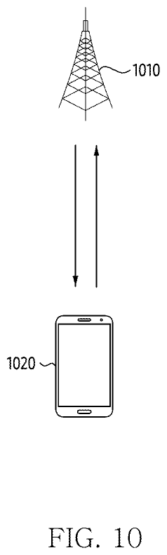

FIG. 10 illustrates a wireless communication system, according to according to an example embodiment.

Referring to FIG. 10, it illustrates a base station 1010 and a terminal 1020 as parts of nodes using a wireless channel in a wireless communication system. Although FIG. 10 illustrates only one base station, the wireless communication system may further include another base station that is the same as or similar to the base station 1010.

The base station 1010 is a network infrastructure that provides wireless access to the terminal 1020. The base station 1010 may have a coverage defined based on a distance capable of transmitting a signal. In addition to the term ‘base station’, the base station 1010 may be referred to as ‘access point (AP), ‘eNodeB (eNB)’, ‘5th generation node’, ‘next generation nodeB (gNB)’, ‘wireless point’, ‘transmission/reception’, or other terms having the same or equivalent meaning thereto.

The terminal 1020, which is a device used by a user, performs communications with the base station 1010 through a wireless channel. A link from the base station 1010 to the terminal 1020 is referred to as a downlink (DL), and a link from the terminal 1020 to the base station 1010 is referred to as an uplink (UL). Further, although not shown in FIG. 10, the terminal 1020 and other terminals may perform communications with each other through the wireless channel. In this context, a link between the terminal 1020 and another terminals (device-to-device link, D2D) is referred to as a side link, and the side link may be used mixed with a PC5 interface. In some other embodiments of the disclosure, the terminal 1020 may be operated without any user's involvement. According to an embodiment of the disclosure, the terminal 1020 is a device that performs machine-type communication (MTC) and may not be carried by a user. In addition, according to an embodiment of the disclosure, the terminal 1020 may be a narrowband (NB)-Internet of things (IoT) device.

The terminal 1020 may be referred to as ‘user equipment (UE), ‘customer premises equipment (CPE), ‘mobile station’, ‘subscriber station’, ‘remote terminal’, ‘wireless terminal’, ‘electronic device’, ‘user device’, or any other term having the same or equivalent technical meaning thereto.

The base station 1010 may perform beamforming with the terminal 1020. The base station 1010 and the terminal 1020 may transmit and receive radio signals in a relatively low frequency band (e.g., FR 1 (frequency range 1) of NR). Further, the base station 1010 and the terminal 1020 may transmit and receive radio signals in a relatively high frequency band (e.g., FR 2 of NR (or FR 2-1, FR 2-2, FR 2-3), FR 3, or millimeter wave (mmWave) bands (e.g., 28 GHz, 30 GHz, 38 GHz, 60 GHz)). In order to improve the channel gain, the base station 1010 and the terminal 1020 may perform beamforming. In this context, the beamforming may include transmission beamforming and reception beamforming. The base station 1010 and the terminal 1020 may assign directionality to a transmission signal or a reception signal. To that end, the base station 1010 and the terminal 1020 may select serving beams through a beam search or beam management procedure. After the serving beams are selected, subsequent communication may be performed through a resource having a quasi-co located (QCL) relationship with a resource that has transmitted the serving beams.

A first antenna port and a second antenna port may be evaluated to be in such a QCL relationship, if the wide-scale characteristics of a channel carrying symbols on the first antenna port can be estimated from a channel carrying symbols on the second antenna port. For example, the wide-scale characteristics may include at least one of delay spread, Doppler spread, Doppler shift, average gain, average delay, and spatial receiver parameters.

Although in FIG. 10, both the base station 1010 and the terminal 1020 are described as performing beamforming, embodiments of the disclosure are not necessarily limited thereto. In some embodiments of the disclosure, the terminal may or may not perform beamforming. Likewise, the base station may or may not perform beamforming. That is to say, only either one of the base station and the terminal may perform beamforming, or both the base station and the terminal may not perform beamforming.

In the disclosure, a beam means a spatial flow of a signal in a radio channel, and may be formed by one or more antennas (or antenna elements), of which formation process may be referred to as beamforming. The beamforming may include at least one of analog beamforming and digital beamforming (e.g., precoding). Reference signals transmitted based on beamforming may include, for example, a demodulation-reference signal (DM-RS), a channel state information-reference signal (CSI-RS), a synchronization signal/physical broadcast channel (SS/PBCH), or a sounding reference signal (SRS). Further, for a configuration for each reference signal, an IE, such as a CSI-RS resource, an SRS-resource, or the like may be used, and the configuration may include information associated with a beam. Beam-associated information may refer to whether a corresponding configuration (e.g., CSI-RS resource) uses the same spatial domain filter as other configuration (e.g., another CSI-RS resource within the same CSI-RS resource set) or uses a different spatial domain filter, or with which reference signal is QCL, or if QCLed, what type (e.g., QCL type A, B, C, or D) it has.

According to the related art, in a communication system with a relatively large cell radius of a base station, each base station was installed so that the respective base station includes functions of a digital processing unit (or distributed unit (DU)) and a radio frequency (RF) processing unit (or radio unit (RU)). However, as high-frequency bands are used in 4th generation (4G) systems and/or its subsequent communication systems (e.g., fifth-generation (5G), and the cell coverage of a base station decreased, the number of base stations to cover a certain area has increased. Thus, it led to more increased burden of initial installation costs for communication providers to install more base stations. In order to reduce the installation costs of the base station, a structure has been proposed in which the DU and the RU of the base station are separated so that one or more RUs are connected to one DU through a wired network and one or more RUs geographically distributed are arranged to cover a specific area.

For example, a method for automated Machine Learning (ML) model training by an electronic device comprising at least one processor comprises running a first ML model and a second ML model, identifying information on an accuracy degradation of the first ML model for a network system using the second ML model, identifying, by the electronic device, that a predicted accuracy degradation corresponds to a pre-defined threshold based on the information on the accuracy degradation of the first ML model, and training the first ML model based on the identifying that the predicted accuracy degradation corresponds to the pre-defined threshold.

For example, the accuracy degradation is due to unplanned events occurring in the first ML model.

For example, the identifying the information on the accuracy degradation of the first ML model using the second ML model, comprises receiving, by the electronic device, data regarding accuracy of the first ML model comprising at least one of: a model type, parameters and hyper parameters, network nodes, cell models, slice/cell configuration information, existing models that can be used for transfer learning, model training time, model prediction accuracies, resources used for model training, extraction times, time window of data extraction, data generation patterns, model accuracy data, and execution time for each training pipeline, storing, by the electronic device, the data regarding the accuracy of the first ML model to a database, and identifying, by the electronic device, the information on the accuracy degradation of the first ML model based on analyzing the data regarding the accuracy of the first ML model with the second ML model.

For example, the training the first ML model comprises identifying, by the electronic device, an expected time for completion of the model training and data extraction based on data of accuracy stored in a database, obtaining, by the electronic device, the data of accuracy of the first ML model from the database, identifying, by the electronic device, incoming requests of the first ML model, identifying, by the electronic device, resources and resource constraints, creating, by the electronic device, a plan for training the first ML model based on the identified incoming requests, the expected time for completion of the training, the identified resources, and the resource constraints, scaling, by the electronic device, up/down and/or in/out the resources based on the created plan, and triggering, by the electronic device, training of the first ML model based on the created plan.

For example, the training the first ML model comprises receiving, by the electronic device, a request to configure a ML service with a new network slice, identifying, by the electronic device, a network slice with the first ML model similar to the new network slice and capable for transfer learning, identifying, by the electronic device, super models of the first ML model used for transfer learning, and remaining layers of the first ML model to be trained based on inputs from a model registry, and triggering, by the electronic device, training of the remaining layers of the first ML model.

For example, the method comprises comparing configuration parameters of a new network slice and configuration parameters of a plurality of network slices based on the threshold configurations, and identifying, based on the comparing configuration parameters of the new network slice and configuration parameters of the plurality of network slices, a network slice with the first ML model similar to the new network slice and capable for transfer learning.

For example, the method comprises obtaining, from a database, the information on the accuracy degradation of the first ML model, identifying first time interval to training the first ML model and second time interval to obtain data for training the first ML model, and identifying, based on the first time interval and the second time interval, a third time interval for training the first ML model, and during the third time interval, training the first ML model.

For example, the method comprises scaling up a resource for training the first ML model and training, based on the resource scaled up, the first ML model.

For example, the method comprises identifying that traffic pattern is changed and identifying that information on key performance data (KPI) is to be changed based on the identifying that traffic pattern is changed.

For example, the method comprises identifying at least one configuration parameter of a network slice related to the first ML model and training, based on the at least one configuration parameter is changed, the first ML model.

For example, an electronic device for automated Machine Learning (ML) model training comprises a memory, at least one processor, and a proactive training engine, coupled to the memory and the at least one processor, the proactive training engine comprising circuitry. The proactive training engine is configured to run a first ML model and a second ML model, identify information on an accuracy degradation of the first ML model for a network system using the second ML model, identify that a predicted accuracy degradation meets a pre-defined threshold based on the information on the accuracy degradation of the first ML model, and train the first ML model based on the identifying that the predicted accuracy degradation corresponds to the pre-defined threshold.

For example, the accuracy degradation is due to unplanned events occurring in the first ML model.

For example, the engine is configured to identify the information on the accuracy degradation of the first ML model using the second ML at least by receiving data regrading accuracy of the first ML model comprising at least one of a model type, parameters and hyper parameters, network nodes, cell models, slice/cell configuration information, existing models that can be used for transfer learning, model training time, model prediction accuracies, resources used for model training, extraction times, time window of data extraction, data generation patterns, model accuracy data, and execution time for each training pipeline, storing the data regarding the accuracy of the first ML model to a database, and identifying the information on the accuracy degradation of the first ML model based on analyzing the data regarding the accuracy of the first ML model with the second ML model.

For example, the engine is configured to train the first ML model at least by identifying an expected time for completion of the model training and data extraction based on data of accuracy stored in a database, obtaining the data of accuracy of the first ML model from the database, identifying incoming requests of the first ML model, identifying resources and resource constraints, creating a plan for training the first ML model based on the identified incoming requests, the expected time for completion of the training, the identified resources, and the resource constraints, scaling up/down and/or in/out the resources based on the created plan, and triggering training of the first ML model based on the created plan.

For example, the engine is configured to train the first ML model at least by receiving a request to configure a ML service with a new network slice, identifying a network slice with the first ML model similar to the new network slice and capable for transfer learning, identifying super models of the first ML model used for transfer learning, and remaining layers of the first ML model to be trained based on inputs from a model registry, and triggering training of the remaining layers of the first ML model.

For example, the engine is configured to compare configuration parameters of a new network slice and configuration parameters of a plurality of network slices based on the threshold configurations, and identify, based on the comparing configuration parameters of the new network slice and configuration parameters of the plurality of network slices, a network slice with the first ML model similar to the new network slice and capable for transfer learning.

For example, the engine is further configured to obtain, from a database, the information on the accuracy degradation of the first ML model, identify first time interval to training the first ML model and second time interval to obtain data for training the first ML model, identify, based on the first time interval and the second time interval, a third time interval for training the first ML model, and during the third time interval, train the first ML model.

For example, the engine is configured to scaling up a resource for training the first ML model and train, based on the resource scaled up, the first ML model.

For example, the engine is configured to identify that traffic pattern is changed and identify that information on key performance data (KPI) is to be changed based on the identifying that traffic pattern is changed.

For example, the engine is configured to identify at least one configuration parameter of a network slice related to the first ML model and train, based on the at least one configuration parameter is changed, the first ML model.

For example, a method for automated Machine Learning (ML) model retraining by an electronic device comprising at least one processor comprises running a first ML model and a second ML model, predicting an accuracy degradation of the first ML model using the second ML model, determining whether the predicted accuracy degradation meets a pre-defined threshold, and retraining the first ML model based on the determination that the predicted accuracy degradation meets the pre-defined threshold.

For example, the accuracy degradation is due to unplanned events occurring in the first ML model.

For example, the predicting the accuracy degradation of the first ML model using the second ML model, comprises receiving, by the electronic device, data regarding accuracy of the first ML model comprising at least one of: a model type, parameters and hyper parameters, network nodes, cell models, slice/cell configuration information, existing models that can be used for transfer learning, model training time, model prediction accuracies, resources used for model training, extraction times, time window of data extraction, data generation patterns, model accuracy data, and execution time for each training pipeline, storing, by the electronic device, the data of accuracy of the first ML model to a retraining datastore, and predicting, by the electronic device, the accuracy degradation of the first ML model based on analyzing the data of accuracy of the first ML model with the second ML model.

For example, the retraining the first ML model comprises estimating, by the electronic device, an expected time for completion of the model retraining and data extraction based on data of accuracy stored in a retraining datastore, extracting, by the electronic device, the data of accuracy of the first ML model from the retraining datastore, predicting, by the electronic device, incoming requests of the first ML model, estimating, by the electronic device, resources and resource constraints, creating, by the electronic device, a plan for retraining the first ML model based on the predicted incoming requests, the expected time for completion of the retraining, the estimated resources, and the resource constraints, scaling, by the electronic device, up/down and/or in/out the resources based on the created plan, and triggering, by the electronic device, retraining of the first ML model based on the created plan.

For example, the retraining the first ML model comprises receiving, by the electronic device, a request to configure a ML service with a new network slice, determining, by the electronic device, a network slice with the first ML model similar to the new network slice and capable for transfer learning, predicting, by the electronic device, super models of the first ML model used for transfer learning, and remaining layers of the first ML model to be retrained based on inputs from a model registry, and triggering, by the electronic device, retraining of the remaining layers of the first ML model.

For example, an electronic device for automated Machine Learning (ML) model retraining, wherein the electronic device comprises a memory, at least one processor, and a proactive retraining engine, coupled to the memory and the at least one processor, the proactive retraining engine comprising circuitry. The proactive retraining engine configured to run a first ML model and a second ML model, predict an accuracy degradation of the first ML model using the second ML model, determine whether the predicted accuracy degradation meets a pre-defined threshold, and retrain the first ML model when the predicted accuracy degradation meets the pre-defined threshold.

For example, the accuracy degradation is due to unplanned events occurring in the first ML model.

For example, the engine is configured to predict the accuracy degradation of the first ML model using the second ML at least by receiving data of accuracy of the first ML model comprising at least one of a model type, parameters and hyper parameters, network nodes, cell models, slice/cell configuration information, existing models that can be used for transfer learning, model training time, model prediction accuracies, resources used for model training, extraction times, time window of data extraction, data generation patterns, model accuracy data, and execution time for each training pipeline, storing the data of accuracy of the first ML model to a retraining datastore, and predicting the accuracy degradation of the first ML model by analyzing the data of accuracy of the first ML model with the second ML model.

For example, the engine is configured to retrain the first ML model at least by estimating an expected time for completion of the model retraining and data extraction based on data of accuracy stored in a retraining datastore, extracting the data of accuracy of the first ML model from the retraining datastore, predicting incoming requests of the first ML model, estimating resources and resource constraints, creating a plan for retraining the first ML model based on the predicted incoming requests, the expected time for completion of the retraining, the estimated resources, and the resource constraints, scaling up/down and in/out the resources based on the created plan, and triggering retraining of the first ML model based on the created plan.

For example, the engine is configured to retrain the first ML model at least by receiving a request to configure a ML service with a new network slice, determining a network slice with the first ML model similar to the new network slice and capable for transfer learning, predicting super models of the first ML model used for transfer learning, and remaining layers of the first ML model to be retrained based on inputs from a model registry, and triggering retraining of the remaining layers of the first ML model.

“Based on” as used herein covers based at least on.

The embodiments disclosed herein can be implemented using at least one hardware device to control the elements.

The foregoing description of the example embodiments will so fully reveal the general nature of example embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while example embodiments herein have been described in terms of preferred embodiments, those skilled in the art will recognize that example embodiments herein can be practiced with modification within the scope of the embodiments as described herein. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

For one or more embodiments, at least one of the components set forth in one or more of the preceding figures may be configured to perform one or more operations, techniques, processes, and/or methods as set forth herein. For example, a processor (e.g., baseband processor) as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The methods according to various embodiments described in the claims and/or the specification of the disclosure may be implemented in hardware, software, or a combination of hardware and software.

When implemented by software, a computer-readable storage medium storing one or more programs (software modules) may be provided. One or more programs stored in such a computer-readable storage medium (e.g., non-transitory storage medium) are configured for execution by one or more processors in an electronic device. The one or more programs include instructions that cause the electronic device to execute the methods according to embodiments described in the claims or specification of the disclosure.

Such a program (e.g., software module, software) may be stored in a random-access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs), other types of optical storage devices, or magnetic cassettes. Alternatively, it may be stored in a memory configured with a combination of some or all of the above. In addition, respective constituent memories may be provided in a multiple number.

Further, the program may be stored in an attachable storage device that can be accessed via a communication network, such as e.g., Internet, Intranet, local area network (LAN), wide area network (WAN), or storage area network (SAN), or a communication network configured with a combination thereof. Such a storage device may access an apparatus performing an embodiment of the disclosure through an external port. Further, a separate storage device on the communication network may be accessed to an apparatus performing an embodiment of the disclosure.

In the above-described specific embodiments of the disclosure, a component included therein may be expressed in a singular or plural form according to a proposed specific embodiment. However, such a singular or plural expression may be selected appropriately for the presented context for the convenience of description, and the disclosure is not limited to the singular form or the plural elements. Therefore, either an element expressed in the plural form may be formed of a singular element, or an element expressed in the singular form may be formed of plural elements.

Meanwhile, specific embodiments have been described in the detailed description of the disclosure, but it goes without saying that various modifications are possible without departing from the scope of the disclosure.

What is claimed is:

1. A method for automated Machine Learning (ML) model training by an electronic device comprising at least one processor, the method comprising:
running a first ML model and a second ML model;
identifying information on an accuracy degradation of the first ML model for a network system using the second ML model;
identifying, by the electronic device, that a predicted accuracy degradation corresponds to a pre-defined threshold based on the information on the accuracy degradation of the first ML model; and
training the first ML model based on the identifying that the predicted accuracy degradation corresponds to the pre-defined threshold.

2. The method as claimed in claim 1, wherein the accuracy degradation is due to unplanned events occurring in the first ML model.

3. The method as claimed in claim 1, wherein the identifying the information on the accuracy degradation of the first ML model using the second ML model, comprises:
receiving, by the electronic device, data regarding accuracy of the first ML model comprising at least one of: a model type, parameters and hyper parameters, network nodes, cell models, slice/cell configuration information, existing models that can be used for transfer learning, model training time, model prediction accuracies, resources used for model training, extraction times, time window of data extraction, data generation patterns, model accuracy data, and execution time for each training pipeline;
storing, by the electronic device, the data regarding the accuracy of the first ML model to a database; and
identifying, by the electronic device, the information on the accuracy degradation of the first ML model based on analyzing the data regarding the accuracy of the first ML model with the second ML model.

4. The method as claimed in claim 1, wherein the training the first ML model comprises:
identifying, by the electronic device, an expected time for completion of the model training and data extraction based on data of accuracy stored in a database;
obtaining, by the electronic device, the data of accuracy of the first ML model from the database;
identifying, by the electronic device, incoming requests of the first ML model;
identifying, by the electronic device, resources and resource constraints;
creating, by the electronic device, a plan for training the first ML model based on the identified incoming requests, the expected time for completion of the training, the identified resources, and the resource constraints;
scaling, by the electronic device, up/down and/or in/out the resources based on the created plan; and
triggering, by the electronic device, training of the first ML model based on the created plan.

5. The method as claimed in claim 1, wherein the training the first ML model comprises:
receiving, by the electronic device, a request to configure a ML service with a new network slice;
identifying, by the electronic device, a network slice with the first ML model similar to the new network slice and capable for transfer learning;
identifying, by the electronic device, super models of the first ML model used for transfer learning, and remaining layers of the first ML model to be trained based on inputs from a model registry; and
triggering, by the electronic device, training of the remaining layers of the first ML model.

6. The method as claimed in claim 5, wherein the method further comprises:
comparing configuration parameters of a new network slice and configuration parameters of a plurality of network slices based on the threshold configurations; and
identifying, based on the comparing configuration parameters of the new network slice and configuration parameters of the plurality of network slices, a network slice with the first ML model similar to the new network slice and capable for transfer learning.

7. The method as claimed in claim 1, wherein the method further comprises:
obtaining, from a database, the information on the accuracy degradation of the first ML model;
identifying first time interval to training the first ML model and second time interval to obtain data for training the first ML model;
identifying, based on the first time interval and the second time interval, a third time interval for training the first ML model; and
during the third time interval, training the first ML model.

8. The method as claimed in claim 1, wherein the method further comprises:
scaling up a resource for training the first ML model; and
training, based on the resource scaled up, the first ML model.

9. The method as claimed in claim 1, wherein the method further comprises:
identifying that traffic pattern is changed; and
identifying that information on key performance data (KPI) is to be changed based on the identifying that traffic pattern is changed.

10. The method as claimed in claim 1, wherein the method further comprises:
identifying at least one configuration parameter of a network slice related to the first ML model; and
training, based on the at least one configuration parameter is changed, the first ML model.

11. An electronic device for automated Machine Learning (ML) model training, wherein the electronic device comprises:
a memory;
at least one processor; and
a proactive training engine, coupled to the memory and the at least one processor, the proactive training engine comprising circuitry, the proactive training engine configured to:
run a first ML model and a second ML model,
identify information on an accuracy degradation of the first ML model for a network system using the second ML model,
identify that a predicted accuracy degradation meets a pre-defined threshold based on the information on the accuracy degradation of the first ML model, and
train the first ML model based on the identifying that the predicted accuracy degradation corresponds to the pre-defined threshold.

12. The electronic device as claimed in claim 11, wherein the accuracy degradation is due to unplanned events occurring in the first ML model.

13. The electronic device as claimed in claim 11, wherein the engine is configured to identify the information on the accuracy degradation of the first ML model using the second ML at least by:
receiving data regrading accuracy of the first ML model comprising at least one of a model type, parameters and hyper parameters, network nodes, cell models, slice/cell configuration information, existing models that can be used for transfer learning, model training time, model prediction accuracies, resources used for model training, extraction times, time window of data extraction, data generation patterns, model accuracy data, and execution time for each training pipeline;
storing the data regarding the accuracy of the first ML model to a database; and
identifying the information on the accuracy degradation of the first ML model based on analyzing the data regarding the accuracy of the first ML model with the second ML model.

14. The electronic device as claimed in claim 11, wherein the engine is configured to train the first ML model at least by:
identifying an expected time for completion of the model training and data extraction based on data of accuracy stored in a database;
obtaining the data of accuracy of the first ML model from the database;
identifying incoming requests of the first ML model;
identifying resources and resource constraints;
creating a plan for training the first ML model based on the identified incoming requests, the expected time for completion of the training, the identified resources, and the resource constraints;
scaling up/down and/or in/out the resources based on the created plan; and
triggering training of the first ML model based on the created plan.

15. The electronic device as claimed in claim 11, wherein the engine is configured to train the first ML model at least by:
receiving a request to configure a ML service with a new network slice;
identifying a network slice with the first ML model similar to the new network slice and capable for transfer learning;
identifying super models of the first ML model used for transfer learning, and remaining layers of the first ML model to be trained based on inputs from a model registry; and
triggering training of the remaining layers of the first ML model.

16. The electronic device as claimed in claim 11, wherein the engine is further configured to:
compare configuration parameters of a new network slice and configuration parameters of a plurality of network slices based on the threshold configurations; and
identify, based on the comparing configuration parameters of the new network slice and configuration parameters of the plurality of network slices, a network slice with the first ML model similar to the new network slice and capable for transfer learning.

17. The electronic device as claimed in claim 11, wherein the engine is further configured to:
obtain, from a database, the information on the accuracy degradation of the first ML model;
identify first time interval to training the first ML model and second time interval to obtain data for training the first ML model;
identify, based on the first time interval and the second time interval, a third time interval for training the first ML model; and
during the third time interval, train the first ML model.

18. The electronic device as claimed in claim 11, wherein the engine is further configured to:
scale up a resource for training the first ML model; and
train, based on the resource scaled up, the first ML model.

19. The electronic device as claimed in claim 11, wherein the engine is further configured to:
identify that traffic pattern is changed; and
identify that information on key performance data (KPI) is to be changed based on the identifying that traffic pattern is changed.

20. The electronic device as claimed in claim 11, wherein the engine is further configured to:
identify at least one configuration parameter of a network slice related to the first ML model; and
train, based on the at least one configuration parameter is changed, the first ML model.
